(19) United States
(12) Patent Application Publication
(10) Pub. No.: US 2012/0185231 A1
(43) Pub. Date: Jul. 19, 2012

(54) Cycle-Count-Accurate (CCA) Processor Modeling for System-Level Simulation

(75) Inventors: Chen-Kang LO, Taipei City (TW); Li-Chun Chen, Taichung City (TW); Meng-Huan Wu, Hsinchu City (TW); Ren-Song Tsay, Jhubei City (TW)

(73) Assignee: National Tsing Hua University, Hsin Chu City (TW)

(21) Appl. No.: 13/008,921

(22) Filed: Jan. 19, 2011

(51) Int. Cl. G06F 17/50

(52) U.S. Cl. 703/21

(57) ABSTRACT

The present invention discloses a cycle-count-accurate (CCA) processor modeling, which can achieve high simulation speeds while maintaining timing accuracy of the system simulation. The CCA processor modeling includes a pipeline subsystem model and a cache subsystem model with accurate cycle with accurate cycle count information and guarantees accurate timing and functional behaviors on processor interface. The CCA processor modeling further includes a branch predictor and a bus interface (BIF) to predict the branch of pipeline execution behavior (PEB) and to simulate the data accesses between the processor and the external components via an external bus, respectively. The experimental results show that the CCA processor modeling performs 50 times faster than the corresponding Cycle-accurate (CA) model while providing the same cycle count information as the target RTL model.

### TECHNICAL FIELD

This invention relates generally to the method of modeling a processor for system-level simulation, and more particularly to a Cycle-Count-Accurate (CCA) processor modeling which shows the superior simulation speed and accuracy and benefits the system design tasks.

### BACKGROUND OF THE RELATED ART

As both system-on-a-chip (SoC) design complexity and time-to-market pressure increase relentlessly, system-level simulation emerges as a crucial design approach for non-recurring engineering (NRE) cost saving and design cycle reduction. With system components, such as processors and busses, modeled at a proper abstraction level, system simulation enables early architecture performance analysis and functionality verification before real hardware implementation.

To construct a proper system platform for simulation, models for system components of various abstraction levels are proposed for simulation accuracy and performance trade-off. For example, Cycle-accurate (CA) models are proposed to eliminate detailed pins and wires to improve simulation performance while preserving cycle timing accuracy. CA models are suitable for micro-architecture verification. The verification of correctness involves detailed states, such as values of register contents at every cycle. In practice, the simulation speeds of CA models are slow because of the enormous number of simulated states and are not satisfactory for system-level simulation.

To further increase simulation performance while sacrificing timing accuracy, cycle-approximate (CX) models apply simple fixed, approximated delays to represent timing behaviors. CX models achieve significant simulation performance speedup and are useful for architecture performance estimation at early design stages. Nevertheless, the approximated timing is inadequate for system simulation such as HW/SW co-simulation or multi-processor simulation. Without precise timing information, both performance evaluation and functionality verification cannot be accurate.

A new modeling approach, i.e., cycle-count-accurate (CCA) approach, has received great attention lately, offering superior simulation performance speedup compared to CA models by eliminating unnecessary timing details while keeping only needed system timing information. Compared to CX, CCA technique preserves accurate cycle count information of execution behaviors, and the preserved accuracy is adequate for system-level simulation.

A CCA processor modeling technique is disclosed in the present invention. The idea is essentially based on the observation that, if the timing and functional behaviors of every access (such as bus access) on a component interface are correct, the effects from the component to the simulated system behaviors will remain correct. In other words, unnecessary internal component details can be eliminated to achieve better simulation performance while maintaining accurate system behaviors, as long as the interface behaviors are correct.

The disclosed CCA processor model of the present invention preserves accurate cycle count information between any two consecutive external interface accesses through pre-abstracted processor pipeline and cache timing information using static analysis.

### SUMMARY

The present invention discloses a Cycle-Count-Accurate (CCA) processor modeling, hereinafter called a CCA processor modeling, for system-level simulation. The CCA processor modeling achieves both fast and accurate simulation for a System-on-a-chip (SoC) design. The CCA processor modeling for system-level system simulation mainly includes a pipeline subsystem model (PSM), hereinafter called PSM, and a cache subsystem model (CSM), hereinafter called CSM. In one embodiment, the CCA processor modeling further includes a branch predictor and a bus interface model.

Instead of observing all internal states at every clock cycle, the PSM analyzes all possible pipeline execution behaviors (PEB), hereinafter called PEB, of a plurality of basic blocks of a given program. First of all, the PSM statically pre-analyzes the numbers of possible PEB for each basic block of a given program. Then, during simulation, the PSM dynamically calculates an actual timing point of an access event by adding a time offset to the starting execution time of a target basic block. The above-mentioned time offset is a pre-analyzed time according to the static PEB analysis.

In one embodiment, the PSM only identifies a potential missed instruction fetch as an access event for simulation, since only it causes external instruction fetches and affects the behavior of the processor interface. The PSM checks the time point for a data access event when a memory load/store or an input/output instruction scheduled in execution stages. In addition, the PSM will dynamically adjust an additional delay cycles to the target basic block while a cache miss happens in simulation.

The CSM returns correct access delay values, depending on hit or miss conditions, to the PSM at the clock cycle when an access event issued from the PSM, and triggers external accesses accurately via a processor interface.

In one embodiment, the CSM includes a hierarchical cache system. The hierarchical cache system issues all external accesses at accurate time points and returns correct access delays to the PSM, depending on hit or miss results of the first and the second level caches.

In one embodiment, the CSM returns only one cycle delay to the PSM if the first level cache hits. On the contrary, given that the first level cache misses, the CSM returns X+1 cycles delay to the PSM because the first level cache requires X cycle before and one cycle after an additional handshake with the second level cache. The aforementioned X is an integer and depends on processor models. In case of the miss happened in the CSM, it will trigger an external memory access according to a pre-analyzed timing.

The bus interface model is used to simulate the behavior of the processor interface, which accesses datum, via an external bus, to and from external components, such as ROM, RAM or other hardware, when the CSM issues a hit miss signal. Only the timing and functional behaviors of the bus interface at the clock cycle of accessing data to/from the external components are extracted for system-level simulation. If the timing and functional behaviors of every bus access on a component interface are correct, the effects from the component to the simulated system behaviors will remain correct. In other words, unnecessary internal component details can be eliminated to achieve fast and accurate system simulation, as long as the interface behaviors are correct.

### BRIEF DESCRIPTION OF THE DRAWINGS

The above objects, and other features and advantages of the present invention will become more apparent after reading the following detailed description when taken in conjunction with the drawings, in which:

FIG. 1(a) illustrates a system-on-a-chip architecture which includes a processor, a bus, and several components outside the processor.

FIG. 1(b) illustrates a sample timing diagram of the bus transfer.

FIG. 2(a) illustrates a Cycle-accurate (CA) model, which captures all the concurrent behaviors of the processor by updating every process state at every clock cycle.

FIG. 2(b) illustrates an abstract processor model, such as CCA processor model, which has different internal execution details compared to CA model, but gives same effects to the system by providing equivalent bus access behaviors.

FIG. 3 illustrates the CCA processor model of the present invention, which includes a pipeline subsystem model (PSM), a cache subsystem model (CSM), a branch predictor, and a bus interface.

FIG. 4(a) illustrates a basic block of a program.

FIG. 4(b) illustrates the pipeline execution behavior (PEB) of a basic block.

FIG. 5(a) illustrates a program segment, which contains a basic block C (BB_{C}).

FIG. 5(b) illustrates a control flow graph (CFG) of the program.

FIG. 5(c) illustrates the pipeline execution behavior (PEB) of the basic block C alone.

FIG. 5(d) illustrates the pipeline execution behavior (PEB) of basic block C following basic block A (BB_{A}).

FIG. 6(a) illustrates a control flow graph (CFG) of the program.

FIG. 6(b) illustrates an example of static analysis of access events in a pipeline execution behavior (PEB).

FIG. 6(c) illustrates an example for dynamic timing calculation.

FIG. 7(a) shows a processor with two hierarchical caches, L1 and L2, and the clocked finite state machine (CFSM) of L1 to describe the cycle-by-cycle state transition behavior of the L1 cache.

FIG. 7(b) illustrates the CFSM being converted into a compressed computation tree. The two paths of the computation tress correspond to the two types of the cache timing behaviors, i.e., hit and miss.

FIG. 7(c) illustrates the CCA cache model is implemented by a procedure call. Different paths in the computation tree are represented by different control flow branches.

FIG. 8 illustrates the cache subsystem model (CSM) simulation behavior and how to return the right cycle delay to the pipeline subsystem model (PSM).

FIG. 9 shows the experimental results which compare the performance of CCA processor model to the other models.

### DETAILED DESCRIPTION

The method of a Cycle-Count-Accurate (CCA) processor modeling is described below. In the following description, more detailed descriptions are set forth in order to provide a thorough understanding of the present invention and the scope of the present invention is expressly not limited expect as specified in the accompanying claims.

The key idea of the CCA modeling technique is to leverage limited observability of component internal states and speed up simulation by eliminating unnecessary internal modeling details without affecting overall system simulation accuracy. In the following, we first discuss the observability property of processor models and then propose a CCA processor model.

For a processor component, only the behaviors on its interface are directly observable to the system (or specifically, to the rest of the system). In other words, a system cannot directly observe and interact with a processor except through the interface.

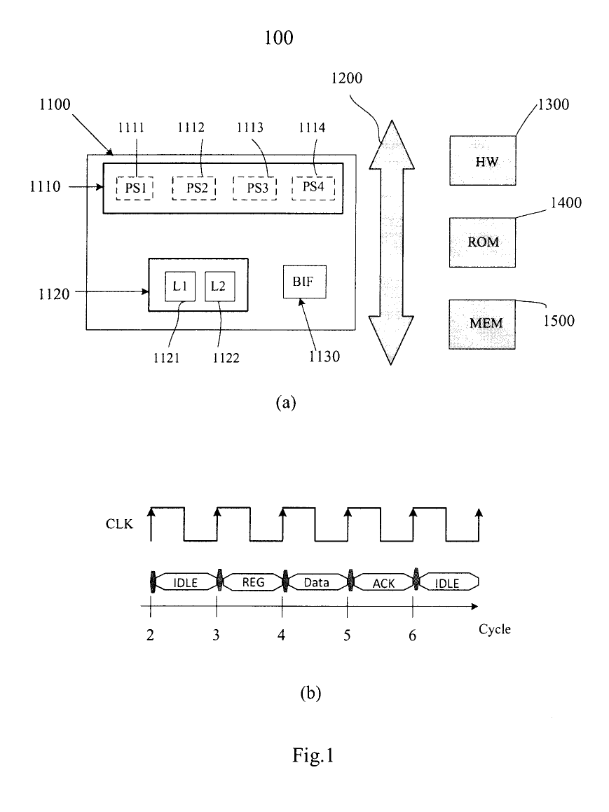

As shown in FIG. 1(a), a system-on-a-chip (SoC) 100 at least includes a processor 1100, an external bus 1200, and a plurality of external components such as a hardware component (HW) 1300, a ROM 1400, and a memory (MEM) 1500. The processor 1100 includes several subsystems such as a pipeline 1110, a cache 1120, and a bus interface (BIF) 1130. A pipeline is like an assembly line: Each step in the pipeline completes a part of the instruction. As shown in FIG. 1 (a), an exemplary pipeline 1110 has four steps 1111, 1112, 1113 and 1114. Therefore, the length of the pipeline 1110 is four and each of these steps is called a pipe stage or a pipe segment. The exemplary cache 1120 can be a single level cache or a hierarchical cache system with two level caches, a first level cache (L1) 1121 and a second level cache (L2) 1122.

In one embodiment, when there is an instruction inside the pipeline requests writing data to the HW 1300, to accomplish the request, the data transferred has passes through the cache 1120 and triggers a bus transfer action on the bus interface (BIF) 1130 and is written to the HW 1300 via an external bus 1200. A sample timing diagram of the bus transfer is shown in FIG. 1(b) for reference. In the transfer process, none of the processor internal behaviors, such as those of the pipeline 1110 and the cache 1120, can directly affect that of the external components 1300 1400 1500 except through the bus access on the interface. In other words, the interface behavior (i.e., the bus access with the data transferred in this example) determines the effects from a component to the system. The fact of limited observability implies that, if two processor models have the same interface behaviors, they have equivalent effects on the system. Therefore, the CCA model of the present invention is more efficient than CA models for system simulation.

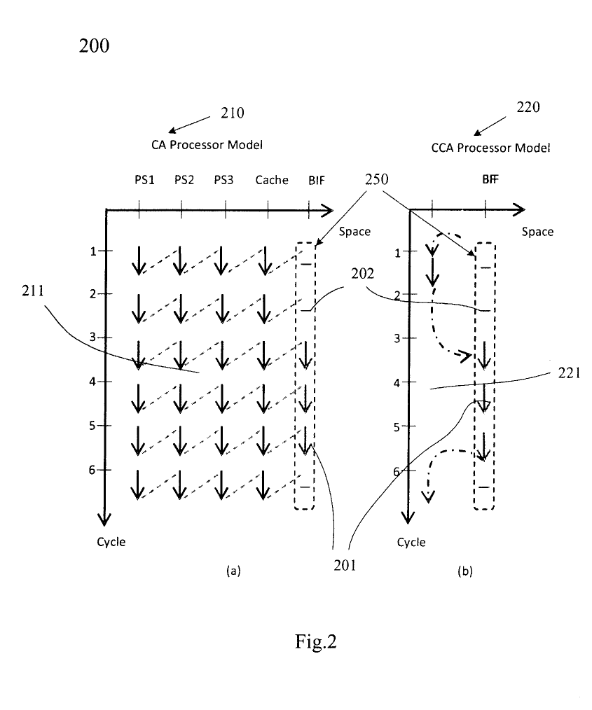

In one embodiment, as shown in FIG. 2(a) and FIG. 2(b), although a CA model 210 and the CCA model 220 of the present invention have different internal execution details 211 and 221, respectively, both models display the same bus access behavior 250. Regarding the bus access behavior 250, the symbol “↓” 201 depicts there is a data access between BIF 1130 and the external bus 1200, and the symbol “—” 202 represents there is no action between BIF 1130 and the external bus 1200. As shown in the FIG. 2, each column shows the internal behavior of a concurrent process, such as a pipeline stage (PS), and each arrow denotes a state evaluation of a process at the numbered clock cycle time. The CA model in FIG. 2(a) captures all the concurrent behaviors of the processor by updating every process state at every clock cycle; in contrast, the CCA model shown in FIG. 2(b) gives same effects to the system by providing equivalent bus access behaviors. By eliminating unnecessary details, the CCA processor model provides exact timing in terms of cycle count on every external interface access point with simplified internal models so that the whole system simulation can both preserve perfect timing accuracy and gain significant simulation performance improvement.

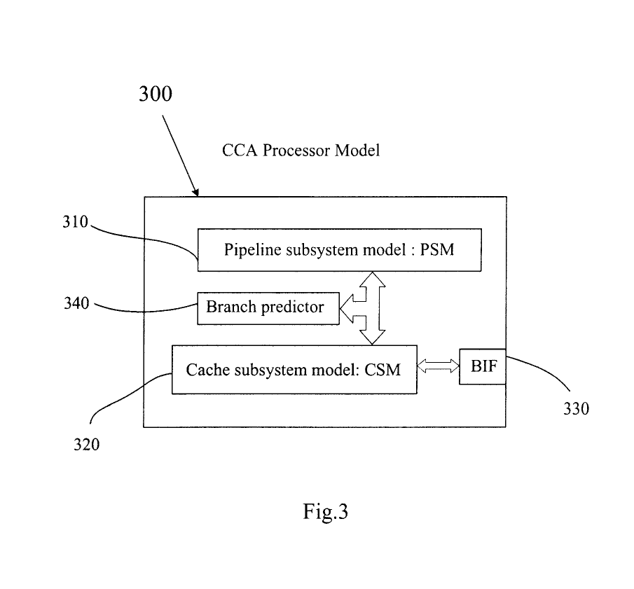

As far as a processor is concerned, in view of all external accesses are initiated from the processor pipeline, and then pass through the caches to the processor interface. Hence, as shown in FIG. 3, the disclosed CCA processor modeling 300 of the present invention includes a pipeline subsystem model (PSM) 310, which issues access events at correct time points, and a cache subsystem model (CSM) 320, which simulates the caches with the access events and triggers external interface accesses accurately, a bus interface model (BIF) 330, which executes the data access to and from an external bus, and a branch predictor 340, which determine the possible pipeline execution behaviors (PEB).

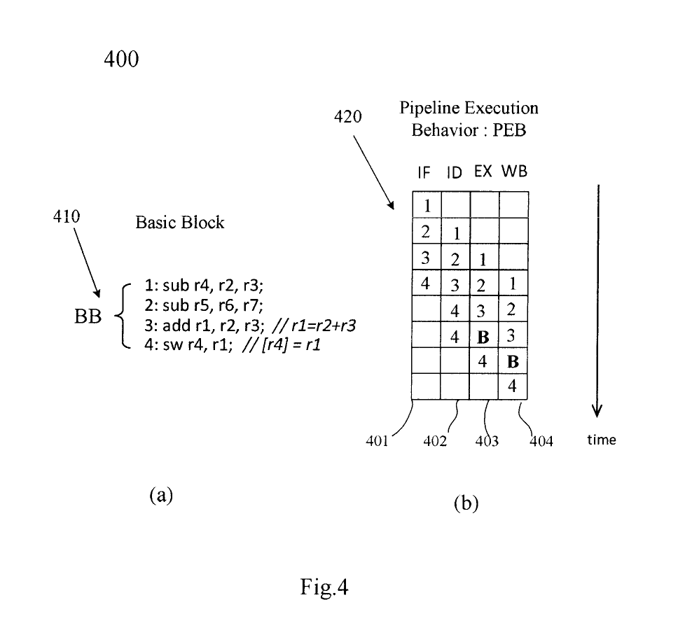

The modeling of pipeline subsystem model (PSM) 310 is described in detail below. In one embodiment, with respect to the pipeline subsystem model (PSM) 310, all possible pipeline execution behaviors (PEBs) of each basic block (BB) of a given program are statically analyzed before a simulation in order to eliminate unnecessary simulation details of the PSM 310. Then at simulation, the actual time points of issuing access events to the CSM 320 are calculated based on the pre-analyzed PEBs. Basic blocks usually form the vertices or nodes in a control flow graph (CFG). Compilers usually decompose programs into their basic blocks as a first step in the analysis process. As shown in FIG. 4(a), a basic block is an optimized code only within a straight-line code fragment and has one entry point and one exit point, meaning only the last instruction can cause the program to begin executing code in a different basic block. Under these circumstances, whenever the first instruction in a basic block is executed, the rest of the instructions are necessarily executed exactly once, in order 401, as shown in FIG. 4(b). Where there is a hazard happened in a pipe stage 402, which prevent the next instruction in the instruction stream from executing during its designated clock cycle, the next pipe stages 403 404 need to insert a Bubble (i.e., NOP) to resolve the data hazard.

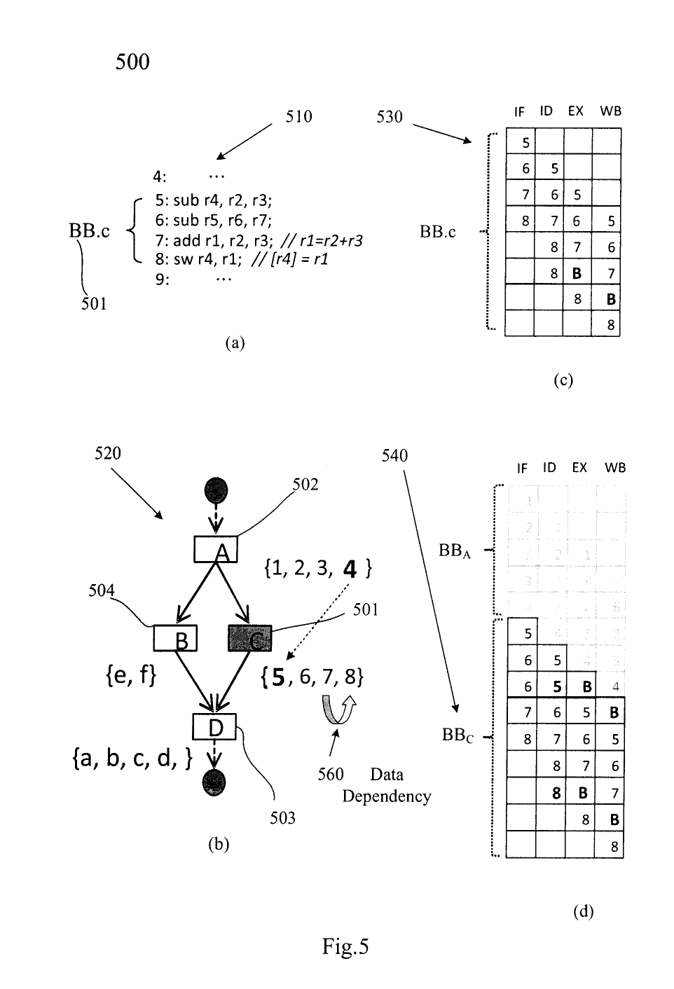

In one embodiment, the pipeline subsystem model (PSM) 310 captures target pipeline architecture and the pipeline execution of any given fixed sequence of instructions can be statically determined. Nevertheless, a complete program cannot be statically analyzed because it contains branches determinable only at runtime. Hence, the pipeline subsystem model (PSM) 310 first statically pre-analyzes each basic block of the program since it contains no branches. As shown in FIG. 5(b), a control flow graph (CFG) 520 is first constructed after analyzing a program 510 in FIG. 5(a). Then, in the condition that a target processor with a 4-stage pipeline being used, the pipeline execution behaviors (PEBs) of the basic block C 501 can be analyzed as shown in FIG. 5(c). The scheduling result 530 of pipeline executions is recorded on a table where its columns represent the pipeline stages and its rows represent cycle times.

In one embodiment, as shown in FIG. 5 (c), a Bubble (B) (i.e., NOP) is inserted in the final pipeline execution to resolve the data hazard between instruction 7 and 8, because of the data dependency 560 between the instructions 7 and 8

In one embodiment, a basic block may have several possible PEBs because its execution could be affected by the executions of its precedent basic blocks. Considering the above-mentioned situation, the CCA processor modeling 300 includes a branch predictor 340, as shown in FIG. 3. Regarding the control flow graph (CFG) 520, as shown in FIG. 5 (b), there would be two possible PEBs for the basic block C 501, one is the PEB 530, as shown in FIG. 5(c), which is previously analyzed and the other one is a new PEB 540, as shown in FIG. 5(d).

In one embodiment, the PEB 530 is the case when the branch predictor 340 fails the branch prediction and the pipeline is flushed and hence the basic block C 501 is executed alone. However, if the branch prediction succeeds, the basic block C 501 is executed immediately following the basic block A 502, as shown in FIG. 5(d). The resolution of the data hazard introduced by instructions 4 and 5 across basic blocks induces an additional delay and produces a different PEB for basic block C 501.

In one embodiment, for efficient PSM simulation, all possible PEBs of every basic block are pre-analyzed. Given a program's CFG, the static analysis finds all strings of precedent blocks (or upward combinations of consecutive precedent blocks) that may induce different PEBs. Owing to the limited length of the pipeline 1110, the number of PEBs is bounded by the pipeline length as well. Therefore, if a precedent block is too far away from the currently analyzed block, the instructions of the two basic blocks cannot be executed simultaneously in the pipeline and such that a new PEB will not be created.

In one embodiment, the basic block D 503 in FIG. 5(b) is a block being analyzed. Tracing back the strings of precedent blocks through the left path of the block D 503, the combination of the basic blocks (D, B, A) 503 504 502 may induce a different PEB from the one induced by (D, B) 503 504 because the block B 504 only has two instructions {e, f}, less than the pipeline length (i.e., 4), and block D 503 could be executed with blocks B 504 and A 502 in the pipeline at the same time. Nevertheless, tracing back the strings of precedent blocks through the right path of the block D 503, the combination of the blocks (D, C, A) 503 501 502 produces the same PEB as blocks (D, C) 503 501, since the block C 501 has four instructions, equal to or more than the pipeline length, and hence the block A 502 is too far from the block D 503 through the right path to have both executed simultaneously. In summary, for each basic block to find all possible PEBs, the static analysis traverses backwardly to find precedent block strings and compute the corresponding PEBs. It stops traversing deeper when the total number of the instructions on the found is equal to or greater than the pipeline length.

In one embodiment, for efficient PSM simulation, the access timing behavior of each PEB is statically analyzed by identifying both instruction and data access events at their corresponding execution time points. For instruction access events, each instruction at the stage of instruction fetch (IF) in PEB is checked to indicate the time point of an instruction cache (I-cache) access occurs. Only instruction accesses which may potentially cause cache misses should be identified as access events for simulation, since only they could cause external accesses and affect interface behaviors.

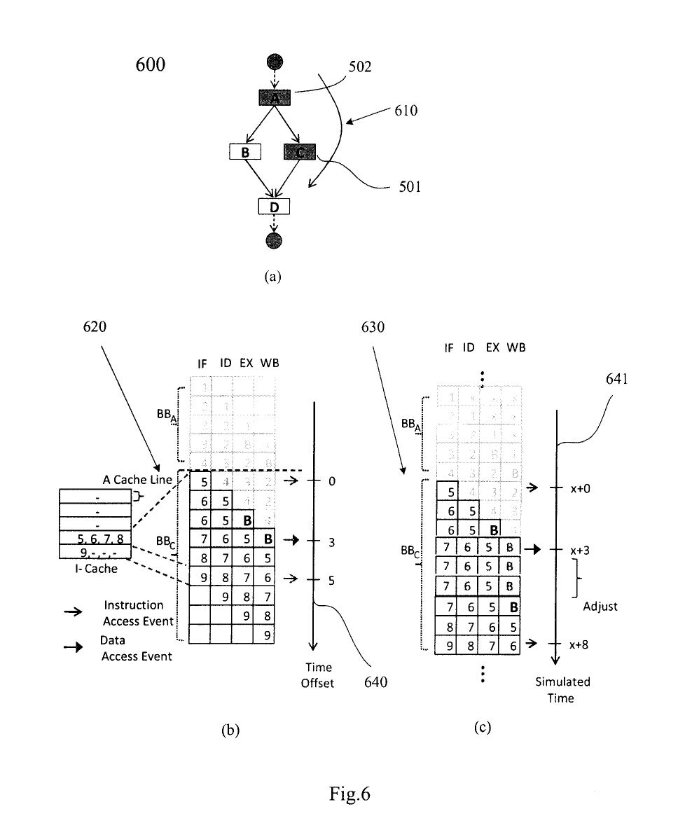

In one embodiment, as shown in FIG. 6(b), for the PEB 620, the instructions 6, 7, 8 are not identified as access events, because they access the same cache block as the instruction 5. The reason is that only the first access of consecutive accesses to a same cache block could potentially cause a miss and restore the cache block and consequently the following accesses always hit. For data access events, only the time points when memory load/store or input/output (I/O) instructions are scheduled in their execution stages will be checked. For example, given that the instruction 5 is a load instruction and hence only a data access event, when the instruction 5 is at the execution (EX) stage, will be identified.

In one embodiment, the method to analyze the PEB 620 is disclosed in FIG. 6(b), where a total of two instruction access events (i.e. 0 and 5) and one data access event (i.e. 3) are identified at their corresponding access time points (i.e., 0, 3, and 5) and are labeled on the time axis 640. Since the start time of the analyzed PEB 620 execution is unknown at static time, we denote these time points using the time offsets from the beginning clock cycle of the PEB.

In one embodiment, the dynamic simulation behavior of the PSM 310 is described below. During dynamic simulation, the PSM 310 issues the access events based on the pre-analyzed PEBs. As shown in FIG. 6(a), given that the branch predictor 340 predicts the PEB 610, the basic block C 501 is executed after basic block A 502 during simulation. Through this, the PEB 540 in FIG. 5(d), whose access events are analyzed in FIG. 6(b), is selected. As shown in FIG. 6(c), the actual access event time points are calculated by adding the pre-analyzed time offsets (assume to be x), which is the pre-analyzed end time point of the block A 502, with the execution start time of the block C 501. Furthermore, assume the second access event of the block C 501 causes a cache miss during simulation and the pipeline is temporarily frozen for a three-cycle delay; accordingly, the third access is adjusted with an additional delay of three cycles (e.g., 5→8), as shown in simulated time 641 of FIG. 6 (c).

As shown in FIG. 3 CCA processor modeling 300 includes a cache subsystem model (CSM) 320. The behavior of CSM 320 will be described in detail in the following sections. For an accurate CCA processor modeling 300, the CSM 320 should return correct access delay time to the access events issued from the PSM 310 and trigger external accesses accurately on the processor bus interface (BIF) 330. Therefore, the idea is to implement a model for each hierarchical cache in CSM 320 such that it can return correct access delay values depending on hit/miss results. In addition, if the first level cache (L1) 1121 misses, the access request is passed on to the second cache (L2) 1122 at correct timing. As a result, if all the cache hierarchies in the CSM 320 behave correctly, access delays to the CSM 320 can be calculated properly and all external accesses will be executed at accurate time points.

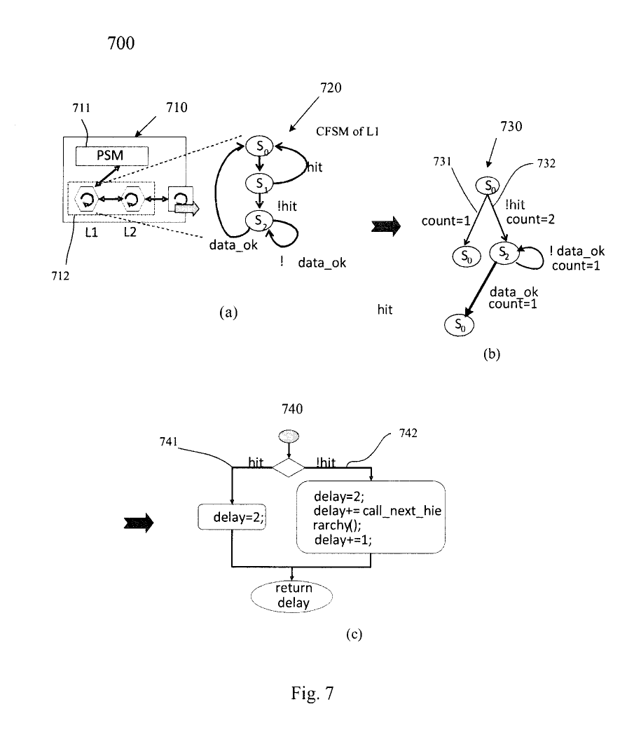

In one embodiment, as shown in FIG. 7(a), a processor 710 has a hierarchical cache system 712 with two level caches, the first level cache L1 and the second level cache L2. For clarity of discussion, we show only the clocked finite state machine (CFSM) 720 which describes the cycle-by-cycle state transition behavior of the L1 cache. Upon an access request, L1's CFSM 720 will perform hit/miss evaluation. Next, if the requested data is hit, the cache L1 will return the requested data and stay in state s0; if not, the state of cache L1 will progress through s1 to s2 and start a handshaking process to request access with the cache L2 until the assertion of signal “data_ok”, which notifies the completion of the cache system 712 restoring.

In one embodiment, the CFSM 720 is converted into a compressed computation tree 730 as in FIG. 7(b). The two paths of the computation tree correspond to the two types of the cache timing behaviors (i.e. hit and miss) for this particular case. The left path 731 of the computation tree describes the hit case, which needs only one cycle for completion. The right path 732 describes the miss case, which needs two cycles before and one cycle after an additional handshake with the next hierarchy.

In one embodiment, the CSM 320 is implemented by a procedure call as in FIG. 7(c). Different paths 741 742 in the computation tree are represented by different control flow branches. Access requests to the next hierarchy are implemented as function invocation to trigger actions in the next hierarchy.

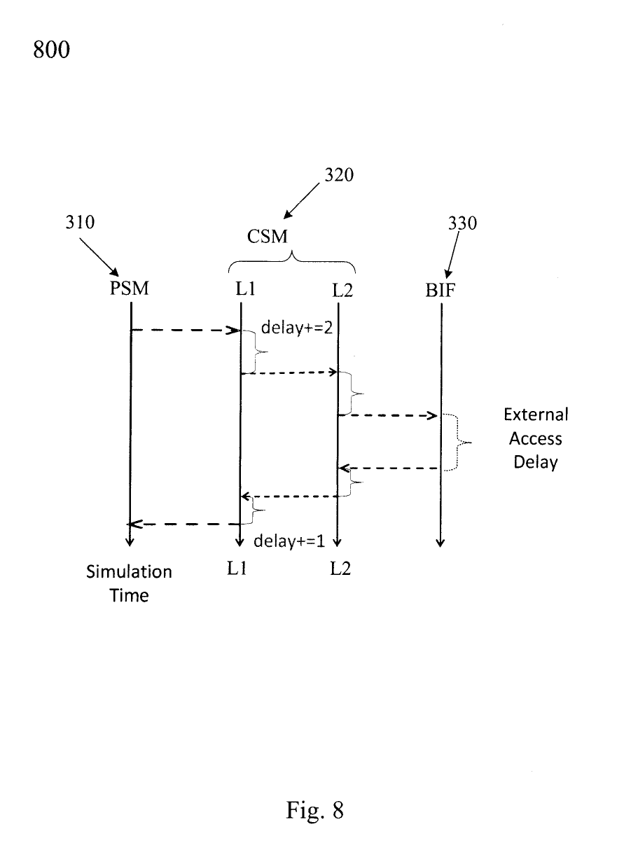

In one embodiment, as shown in FIG. 8, a simulation behavior of the CSM 320 is illustrated. Once the PSM 310 requests an access to the CSM 320, the access is passed onto the L1 cache. Assume that the access causes a miss and consequently the L1 cache triggers an access to the next cache hierarchy after a two-cycle delay. Subsequently, if L2 also misses, it will trigger external memory access accurately according to its pre-analyzed timing. On the other hand, if the access is a hit in either L1 or L2, the procedure will return immediately with an accurate delay value.

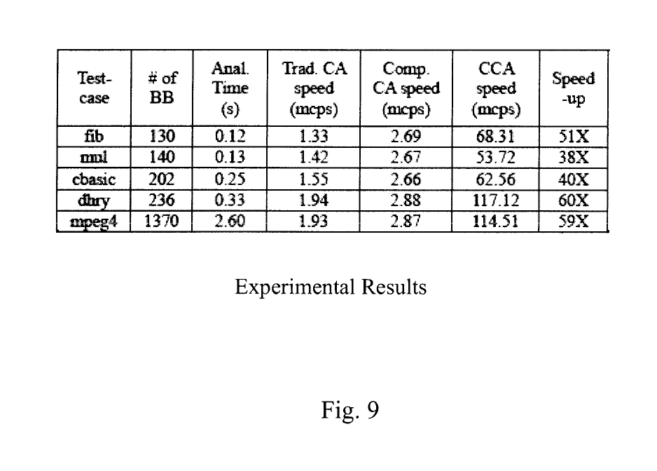

A CCA processor modeling 300 including the PSM 310 and CSM 320 and optionally including the bus interface model 330 and the branch predictor 340, shows the superior simulation speed and accuracy based on some experimental results. The experimental results are shown in FIG. 9 and most test cases are from OpenRISC official test-benches. Additionally, a 32-frame MPEG-4 QCIF video application is tested on the platform, where the processor fetches the encoded frames from the ROM for decoding and transfers the decoded frames to the LCD for display.

For accuracy verification, the simulated clock times of bus accesses from the generated CCA processor modeling 300 are checked against that of the target RTL model. Also, each test-case run on the generated CCA modeling 300 has the same execution cycle count as on the RTL model.

Simulation speeds are shown in million cycles per second (MCPS) for comparison. The proposed model, CCA processor modeling 300, is on average 50 times faster than the Traditional CA simulator, an interpretive ISS with a CA timing model. In comparison, Compiled CA, which uses the compiled ISS technique with the CA timing model, is barely twice the speed of the Traditional CA approach. This shows that no significant simulation speed-up can be achieved when only using a fast ISS technique with the CA timing model, because the CA timing simulation contributes a great portion of simulation time.

The FIG. 9 also lists the pre-analysis time (Anal. time) of each test-case. It linearly increases as the number of basic blocks grows but is still negligible compared to the large simulation time. For example, the MPEG-4 case takes seconds for pre-analysis but minutes for simulation.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A CCA processor modeling for system-level simulation comprising:
a pipeline subsystem model analyzing a pipeline execution behavior (PEB) without maintaining all internal pipeline states at every cycle; and
a cache subsystem model coupled to said pipeline subsystem model for returning correct access delay values, depending on hit or miss conditions, to said pipeline subsystem model and trigging external accesses accurately via a processor interface.

2. The CCA processor modeling according to claim 1, further comprises a bus interface model accessing data, via an external bus, from external components when said cache subsystem model encounter a miss condition.

3. The CCA processor modeling according to claim 1, wherein said PEB analysis statically pre-analyzes each of said basic blocks.

4. The CCA processor modeling according to claim 1, wherein said PEB analyzes a plurality of basic blocks of a given program and possible precedent basic blocks of each said basic block.

5. The CCA processor modeling according to claim 1, wherein said pipeline subsystem model only identifies a potential missed instruction fetch as an access event for simulation, since hit instruction fetch does not cause external accesses and affect the behavior of said processor interface.

6. The CCA processor modeling according to claim 1, wherein said pipeline subsystem model obtains a memory access delay from said cache subsystem model when a memory load/store or an input/output instruction are executed.

7. The CCA processor modeling according to claim 1, wherein said pipeline subsystem model dynamically calculates an actual timing point of an access event by adding a time offset to the starting execution time of said basic block.

8. The CCA processor modeling according to claim 7, wherein said time offset is a pre-analyzed time by said PEB analysis.

9. The CCA processor modeling according to claim 1, wherein said pipeline subsystem model dynamically adjusts an additional delay cycle according to said cache subsystem model.

10. The CCA processor modeling according to claim 1, wherein said cache subsystem model comprises a hierarchical cache system and returns correct access delay values depending on hit or miss results for each cache level.

11. The CCA processor modeling according to claim 10, wherein said hierarchical cache system comprises at least one cache.

12. The CCA processor modeling according to claim 10, wherein said cache subsystem model returns correct access delays to said pipeline subsystem model and all external accesses are executed at accurate time points when said hierarchical cache system misses.

13. The CCA processor modeling according to claim 10, wherein said cache subsystem model returns a delay to said pipeline subsystem model if said hierarchical cache system hits.

14. The CCA processor modeling according to claim 10, wherein said cache subsystem model triggers an external memory access according to a pre-analyzed timing if said hierarchical cache system misses.

15. A cycle count accurate (CCA) processor modeling for system-level simulation comprising:
a pipeline subsystem model analyzing a pipeline execution behavior (PEB) instead of observing all internal states on every clock cycle;
a cache subsystem model comprising a hierarchical cache system, wherein said cache subsystem model is coupled to said pipeline subsystem model to returns a correct access cycle delay to said pipeline subsystem model depending on hit or miss conditions of said hierarchical cache system thereon;
a bus interface coupled to said cache subsystem model for accessing datum from external components via an external bus when said hierarchical cache system misses; and
only the timing and functional behaviors of said bus interface at the clock cycle of accessing data to/from said external components are extracted for system-level simulation.

16. The CCA processor modeling according to claim 15, wherein said pipeline subsystem model executes a pipeline execution behavior (PEB) analysis.

17. The CCA processor modeling according to claim 15, wherein said PEB analysis statically pre-analyzes each said basic block and determines a number of PEB of each said basic block.

18. The CCA processor modeling according to claim 15, wherein said hierarchical cache system comprises at least a cache.
